(19) United States
(12) Patent Application Publication
(10) Pub. No.: US 2022/0065296 A1
(43) Pub. Date: Mar. 3, 2022

(54) CAGE SEGMENT FOR ROLLING-ELEMENT BEARING, IN PARTICULAR A LARGE-DIAMETER ROLLING-ELEMENT BEARING

(71) Applicant: AKTIEBOLAGET SKF, Goteborg (SE)

(72) Inventor: Bruno Capoldi, Charentenay (FR)

(21) Appl. No.: 17/385,189

(22) Filed: Jul. 26, 2021

(30) Foreign Application Priority Data
Sep. 2, 2020 (DE) 102020211034.4

(51) Int. Cl. F16C 33/46; F16C 19/36

(52) U.S. Cl. CPC F16C 33/467; F16C 19/361

(57) ABSTRACT

A cage segment for a rolling-element bearing includes at least two pockets each configured to receive at least one first roller, and two circumferentially opposite end portions delimiting the cage segment in a circumferential direction, where each end portion has a concave cylindrical abutment face configured to guide a second roller. Also a rolling element bearing including a plurality of the cage segments.

### CROSS-REFERENCE

This application claims priority to German patent application no. 10 2020 211 034.4 filed on Sep. 2, 2020, the contents of which are fully incorporated herein by reference.

### TECHNOLOGICAL FIELD

The present invention relates to the field of bearings, and, more specifically, to the field of large-diameter rolling-element bearings that can accommodate axial and radial loads, and that have an inner ring and an outer ring arranged concentrically about an axis of rotation running in an axial direction.

### BACKGROUND

Large-diameter rolling-element bearings may be used for example in a tunnel boring machine, in a mining extraction machine, in a big offshore crane or in a wind turbine.

A large-diameter rolling-element bearing comprises generally two concentric inner and outer rings and a bearing assembly comprising two rows of axial rollers and one row of radial rollers. Such rolling-element bearings are generally loaded, both axially and radially, often with a relatively large load.

For such a large-diameter rolling-element bearing, it is known to use a segmented cage to receive the contact rollers. The segmented cage comprises a plurality of successive cage segments abutting in the circumferential direction one relative to the other and each configured to receive at least two contact rollers.

Otherwise, depending on the use of roller bearing, considerable forces may arise, which may cause deformation of the bearing, notably of the rotating ring, leading in some cases to local separation of the rings. As a matter of fact, a radial gap between the rotating ring and the fixed ring of the roller bearing can be created.

In order to overcome this drawback, the rolling-element bearing disclosed in patent EP-B1-2 092 204 comprises two opposite rows of radial cylindrical rollers and two opposite rows of axial cylindrical rollers disposed in such a way to surround a nose ring of the rotating ring.

However, the radial dimensions of such roller bearings require a considerable installation space. The mounting of the four rows of cylindrical rollers also requires a large number of assembly steps.

### SUMMARY

An aspect of the present disclosure is to overcome these drawbacks.

The disclosure relates to a cage segment for a rolling-element bearing comprising at least two pockets each configured to receive at least one roller, and two opposite abutting portions delimiting the cage segment in the circumferential direction.

According to a general feature, each abutting portion is provided with a concave outer abutting face having the shape of a cylinder segment.

With such design, in the mounted position in the associated rolling-element bearing, a radial roller may be circumferentially interposed between two successive cage segments delimiting pockets for axial rollers.

The terms “axial rollers” is understood to mean rollers adapted to accommodate axial loads only whereas the terms “radial roller” is understood to mean roller adapted to accommodate radial loads only.

With such an arrangement of the at least one radial roller, radial deformation of the rolling-element bearing and of the gap opening between the inner ring and the outer ring of the associated rolling-element bearing in the radial direction are limited.

Two functions are achieved in the row having both the radial roller and axial rollers.

Otherwise, with regard to a conventional rolling-element bearing comprising two rows of radial cylindrical rollers, the number of parts used to form the rings with the new design of the associated rolling-element bearing is limited. The installation space required is reduced and the design of the associated rolling-element bearing is compact. The number of assembly steps is also reduced.

The cage segment may comprise inner and outer cylindrical portions extending in the circumferential direction and delimiting the cage segment in the radial direction, the inner and outer cylindrical portions having inner contact surfaces facing each other and forming bearing surfaces for the end faces of the roller of each pocket.

Preferably, the axis of the cylinder segment of each abutting face extends perpendicular to the axis of the roller of each pocket.

The axis of the cylinder segment of each abutting face may be offset outwards in the circumferential direction with regard to the abutting face. Preferably, the axes of the cylinder segments of the abutting faces are parallel to each other. The abutting faces may be symmetric with respect to a radial plane passing through the center of the cage segment.

The disclosure also relates to a rolling-element bearing comprising a first ring, a second ring, at least one row of radial rolling elements radially interposed between axial raceways of the rings, at least one row of axial rollers axially interposed between radial raceways of the rings and radially located between axial guiding faces of the rings, and at least one segmented cage for maintaining the row of axial rollers and comprising a plurality of successive circumferential cage segments as previously defined. Each pocket of the cage segments receiving at least one axial roller.

The rolling-element bearing further comprising one radial roller circumferentially interposed between each abutting face of each cage segment of the segmented cage and the facing abutting face of the adjacent cage segment. The radial rollers are radially interposed between the axial guiding faces of the rings.

The second ring may comprise a protruding nose engaged into an annular groove of the first ring and having an axial cylindrical surface on which is formed the axial raceway of the second ring.

In one embodiment, the rolling-element bearing further comprises at least one additional row of axial rolling elements axially interposed between radial raceways of the first and second rings. The row of axial rollers and the additional row of axial rolling elements may be disposed axially on each side of the protruding nose of the second ring.

The row of axial rolling elements and the row of radial rolling elements may comprise cylindrical rollers.

### BRIEF DESCRIPTION OF THE DRAWINGS

The present invention and its advantages will be better understood by studying the detailed description of specific embodiments given by way of non-limiting examples and illustrated by the appended drawings on which:

FIGS. 1 and 2 are partial cross-sections of a rolling-element bearing according to an embodiment of the disclosure.

FIG. 3 is a partial perspective view of a segmented cage and rollers of the rolling-element bearing of FIGS. 1 and 2.

FIG. 4 is a perspective view of a cage segment of the segmented cage of FIG. 3.

### DETAILED DESCRIPTION

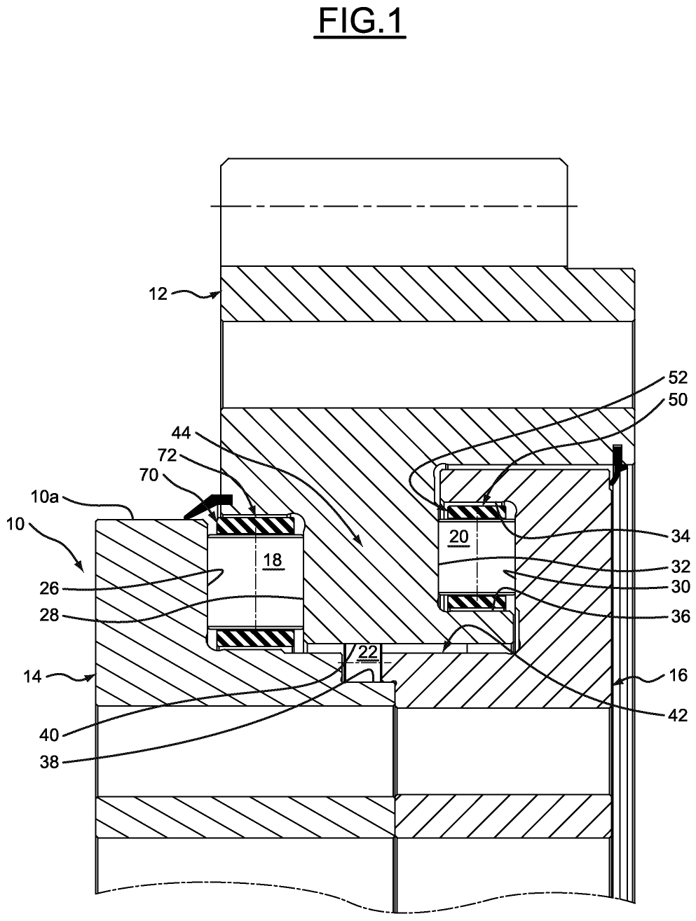

The rolling-element bearing as illustrated on FIG. 1 is a large-diameter rolling-element bearing comprising a first ring 10 and a second ring 12. In the illustrated example, the first ring 10 is the inner ring whereas the second ring 12 is the outer ring. In this example, the outer ring 12 is a rotatable ring and the inner ring 10 is a non-rotatable ring. The rolling-element bearing may for example be used in a tunnel boring machine, a wind turbine, in a big offshore crane or any other applications using a large diameter rolling-element bearing.

The inner and outer rings 10, 12 are concentric and extend axially along the bearing rotation axis (not shown) which runs in an axial direction. The rings 10, 12 are of the solid type.

The inner ring 10 is formed as a split ring and comprises a first ring 14 and a second ring 16 stacked one relative to the other in the axial direction. Each of the first and second rings 14, 16 of the inner ring is provided with a plurality of aligned through-holes (not shown) in order to be joined by fitting bolts.

In the illustrated example, the rolling-element bearing comprises two rows of axial rollers 18, 20 which are arranged between the inner and outer rings 10, 12 in order to form an axial thrust, and a row of radial rollers 22 arranged between the rings to form a radial thrust.

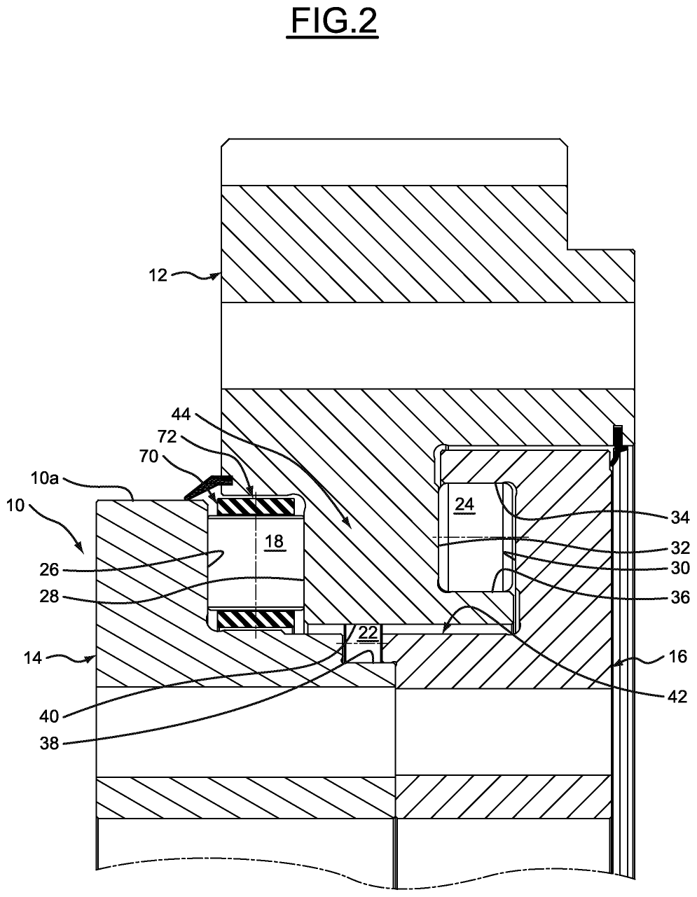

As will be described hereinafter, the rolling-element bearing also comprises radial rollers 24 (FIG. 2) circumferentially disposed between the axial rollers 20 of the row.

The rollers 18, 20, 22 of one row are identical to one another. Each roller 18, 20, 22 comprises a cylindrical outer rolling surface. Each roller 18, 20, 22 further comprises two opposite end faces delimiting the outer rolling surface.

The axis of rotation of each roller 22 is parallel to the axis of the bearing and perpendicular to the axes of each or the rollers 18, 20. In the illustrated example, the axial length of the rollers 18 is larger than the one of the rollers 20. Alternatively, the axial length of the rollers 18 may be smaller than, or may be equal to, the one of the rollers 20.

The axial rollers 18 are interposed axially between annular radial raceways 26, 28 respectively formed on the inner and outer rings 10, 12. The raceways 26, 28 face each other in the axial direction.

The axial rollers 20 are interposed axially between annular radial raceways 30, 32 respectively formed on the inner and outer rings 10, 12. The raceways 30, 32 axially face each other. The rows of axial rollers 18, 20 are spaced apart from each other in the axial direction. The axial rollers 20 are located radially between annular axial guiding faces 34, 36 respectively formed on the inner and outer rings 10, 12. The guiding faces 34, 36 face each other in the radial direction. Each guiding face 30, 32 is straight and disposed perpendicular to the corresponding raceway 30, 32.

The raceway 30 and the guiding face 34 of the inner ring define together with the raceway 32 and the guiding face 36 of the outer ring an annular space inside which the axial rollers 20 are housed. The rolling surface of each axial roller 20 is in axial contact with the raceways 30, 32.

The radial rollers 22 are interposed radially between annular axial raceways 38, 40 respectively formed on the inner and outer rings 10, 12. The raceways 38, 40 face each other in the radial direction. The row of radial rollers 22 is radially offset inwards with respect to the rows of axial rollers 18, 20. The row of radial rollers 22 is axially located between the rows of axial rollers 18, 20.

The inner ring 10 comprises an annular groove 42 opening in a radial direction outwardly towards the outer ring 12. The inner ring 10 comprises an outer stepped cylindrical surface 10a from which the groove 42 is formed.

The outer ring 12 comprises an annular protruding nose 44 engaging into the annular groove 42 of the inner ring. The nose 44 extends radially inwards. The protruding nose 44 protrudes radially from an inner cylindrical surface or bore of the outer ring.

The rows of axial rollers 18, 20 are arranged axially between the nose 44 of the outer ring and the groove 42 of the inner ring. The rows of axial rollers 18, 20 are disposed on each side of the nose 44. The radial raceways 28, 32 are located on the nose 44. The radial raceways 26, 30 are located on the groove 42 of the inner ring.

The row of radial rollers 22 is arranged radially between the nose 44 of the outer ring and the groove 42 of the inner ring. The axial raceways 38, 40 are respectively located on the groove 42 and the nose 44. An inner cylindrical surface or bore of the nose 44 delimits the axial raceway 40. An axial bottom of the groove 42 delimits the axial raceway 38. The axial raceway 38 radially faces the inner cylindrical bore of the nose 44 onto which is formed the axial raceway 40.

In the illustrated example, the outer ring 12 is made in one part. Alternatively, the outer ring 12 may be divided in the axial direction in at least two separate parts secured together. As previously mentioned, the inner ring 10 is divided in the axial direction in two separate parts, the first ring 14 and the second ring 16. The first and second rings 14, 16 delimit together the groove 42.

The rolling-element bearing further comprises a cage 50 for maintaining the axial rollers 20 spaced apart in the circumferential direction. The cage 50 maintains a regular circumferential spacing between the axial rollers 20. The cage 50 is housed inside the annular space defined by the raceway 30 and the guiding face 34 of the inner ring and the raceway 32 and the guiding face 36 of the outer ring. Each axial roller 20 is maintained by the cage 50 which may bear against the guiding faces 34, 36, 32.

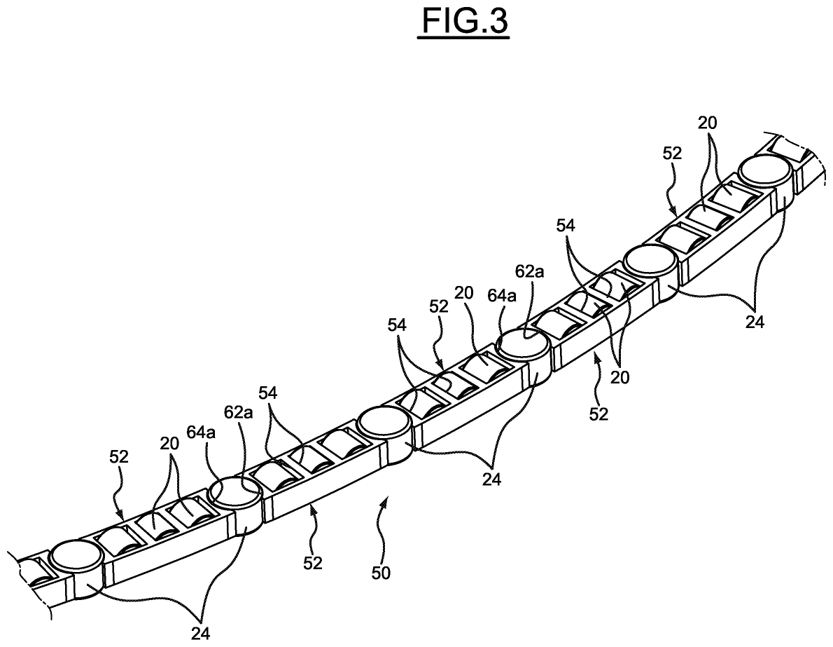

The cage 50 is segmented and is formed by a plurality of successive cage segments 52 as shown on FIG. 3. The cage 50 is formed as a split cage. A radial roller 24 is circumferentially interposed between each pair of two adjacent cage segments 52 of the segmented cage. Each radial roller 24 abuts against one of the cage segments 52 on one side and against the adjacent cage segment 52 on the other side.

Each cage segment 52 of the segmented cage delimits a plurality of pockets 54 each configured to receive one axial roller 20. Each cage segment 52 may advantageously be made in one part, for example from metal such as steel, brass or from plastic material. In the illustrated example, the cage segments 52 are identical one to another.

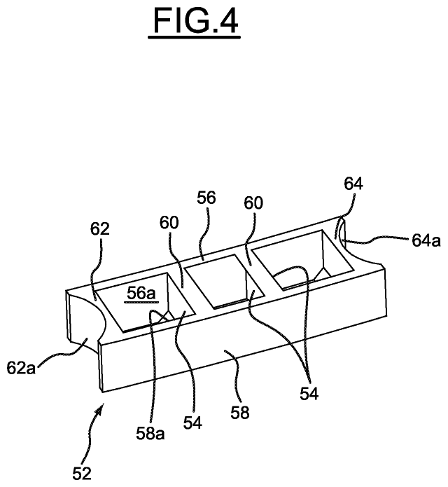

As shown more clearly on FIG. 4, each cage segment 52 is provided with an inner cylindrical portion 56 and an opposite outer cylindrical portion 58 which extend in the circumferential direction. The inner and outer cylindrical portions 56, 58 delimit the cage segment in the radial direction.

The inner cylindrical portion 56 comprises an outer face (not referenced) oriented radially inward towards the guiding face 36 of the outer ring (FIG. 1). The outer cylindrical portion 58 comprises an opposite outer face (not referenced) oriented outward towards the guiding face 34 of the inner ring (FIG. 1). These outer faces delimit the cage segment 36 in the radial direction. In the mounted position into the rolling-element bearing, the outer face of the inner cylindrical portion 56 delimits partly the bore of the segmented cage, and the outer face of the outer cylindrical portion 58 delimits partly the outer surface of the cage.

The inner and outer cylindrical portions 56, 58 of each cage segment have inner contact surfaces 56a, 58a facing each other and forming bearing surfaces for the end faces of the associated roller 20 (FIG. 3) of each pocket. The spacing between the contact surfaces 56a, 58a is substantially equal to the length of the roller 20.

In order to delimit the successive pockets 54, each cage segment 52 comprises a plurality of bridges 60 extending radially between the inner and outer cylindrical portions 56, 58 and connected to the portions.

In the illustrated example, each cage segment 52 comprises three pockets 54. Alternatively, each cage segment 52 may comprise a different number of pockets. Preferably, each cage segment 52 is provided with at least two pockets 54.

Each cage segment 52 of the segmented cage also comprises two opposite abutting portions 62, 64 delimiting the cage segment in the circumferential direction and each comprising an outer abutting face 62a, 64a.

Referring once again to FIG. 3, each radial roller 24 is circumferentially interposed between the outer abutting face 62a of one cage segment 52 and the outer abutting face 64a of the adjacent cage segment 52. Each outer abutting face 62a, 64a of each cage segment 52 forms a local raceway for the associated radial roller 24. The abutting faces 62a, 64a of each cage segment are symmetric with respect to a radial plane passing through the center of the cage segment.

Each abutting face 62a, 64a has a concave form having the shape of a cylinder segment as shown on FIG. 4. The radius of curvature of each abutting face 62a, 64a is slightly greater than the radius of the associated radial roller 24. The axis of the cylinder segment of each abutting face 62a, 64a of each cage segment extends perpendicular to the axis of the associated axial roller of each pocket 54 of the cage segment. The axis of the cylinder segment of each abutting face 62a, 64a is coaxial with the axis of the associated radial roller 24. The axis of the cylinder segment of the abutting face 62a of each cage segment and the axis of the cylinder segment of each abutting face 64a of the cage segment are parallel to each other. The axis of the cylinder segment of each abutting face 62a, 64a is offset outwards in the circumferential direction with regard to the abutting face.

The radial rollers 24 are identical to one another. Each radial roller 24 comprises a cylindrical outer rolling surface. The axis of rotation of each radial roller 24 is parallel to the axis of the bearing and perpendicular to the axes of each or the axial rollers 18, 20.

Referring to FIG. 2, the radial rollers 24 are interposed radially between the axial guiding faces 34, 36 of the inner and outer rings. The rolling surface of each radial roller 24 is in radial contact with the axial guiding faces 34, 36. The radial rollers 24 are located axially between the radial raceways 30, 32 of the inner and outer rings.

The rolling-element bearing also comprises a cage 70 for maintaining the axial rollers 18 spaced apart in the circumferential direction. The cage 70 is segmented and is formed by a plurality of successive cage segments 72 abutting in the circumferential direction one relative to the other. The cage 70 is formed as a split cage.

Otherwise, as previously mentioned, in this illustrated example, the first ring of the rolling-element bearing is the inner ring 10 whereas the second ring is the outer ring 12.

As an alternative, it could be possible to provide a reversed arrangement with the first ring forming the outer ring and the second ring forming the inner ring. In this case, the groove formed on the inner ring opens radially inwards and the nose of the outer ring extends radially outwards.

In the described examples, the rolling-element bearing is provided with a rolling-element bearing comprising three rows of rolling elements. Alternatively, the rolling-element bearing may comprise only two rows of rolling elements, or four or more rows of rolling elements. In the illustrated example, the rolling elements 18, 22 are rollers. The rolling-element bearing may comprise other types of rolling elements 18 and 22, for example balls.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved cage segments for large rolling-element bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A cage segment for a rolling-element bearing comprising:
at least two pockets each configured to receive at least one first roller, and
two circumferentially opposite end portions delimiting the cage segment in a circumferential direction,
wherein each end portion has a concave cylindrical abutment face configured to guide a second roller.

2. The cage segment according to claim 1,
further comprising inner and outer cylindrical portions extending in the circumferential direction and delimiting the cage segment in a radial direction, the inner and outer cylindrical portions having inner contact surfaces facing each other and forming bearing surfaces for the end faces of the roller of each of the at least two pockets.

3. The cage segment according to claim 1, wherein an axis of each cylindrical abutment face is perpendicular to the axis of the at least one first roller.

4. The cage segment according to claim 3, wherein the axis of each cylindrical abutment face is offset outwards in the circumferential direction with regard to each cylindrical abutment face.

5. The cage segment according to 4, wherein the axes of the cylindrical abutment faces are parallel to each other.

6. The cage segment according to claim 5, wherein the cylindrical abutment faces are symmetric with respect to a radial plane passing through a center of the cage segment.

7. A rolling-element bearing comprising:
a first ring,
a second ring,
at least one row of radial rollers radially interposed between axial raceways of the first ring and the second ring,
at least one row of axial rollers axially interposed between radial raceways of the first ring and the second ring and radially located between axial guiding faces of said rings, and
a plurality of the cage segments according to claim 1,
each of the at least two pockets containing at least one of the axial rollers,
the rolling-element bearing further comprising one radial roller circumferentially interposed between each pair of adjacent cage segments, said radial rollers being radially interposed between the axial guiding faces of the first and second ring.

8. The rolling-element bearing according to claim 7,
wherein the pairs of adjacent cage segments are spaced apart by the radial rollers.

9. The rolling-element bearing according to claim 7, wherein the second ring comprises a protruding nose projecting into an annular groove of the first ring and provided with an axial cylindrical surface on which is located the axial raceway of said second ring.

10. The rolling-element bearing according to claim 7,
wherein the at least one row of axial rollers comprises a first row of axial rollers and a second row of axial rollers.

11. The rolling-element bearing according to claim 10, wherein the first and second rows of axial rollers are disposed axially on each side of the protruding nose of the second ring.

12. A cage segment for a rolling-element bearing comprising:
a first pocket and a second pocket each configured to receive a first roller having an axis of rotation extending in a first direction, and
first and second circumferentially spaced end portions delimiting the cage segment in a circumferential direction,
wherein each end portion has a concave cylindrical abutment face configured to guide a second roller having an axis of rotation extending in a second direction perpendicular to the first direction.

13. A rolling-element bearing comprising:
an inner ring including an annular groove,
an outer ring including a projecting nose extending into the annular groove,
a plurality of cage segments according to claim 12 between a wall of the nose and a wall of the annular groove,
a first roller in each of the first and second pockets, and
a plurality of the second rollers, each of the second rollers contacting one of the concave cylindrical abutment faces.

14. The rolling-element bearing according to claim 13,
wherein the plurality of cage segments are spaced apart by the plurality of second rollers.
